(19) United States
(12) Patent Application Publication
(10) Pub. No.: US 2026/0320718 A1
(43) Pub. Date: Oct. 15, 2026

(54) AUTOMATED SYSTEM AND METHOD FOR MANAGING THE CONSUMMATION OF TRANSACTIONS

(71) Applicant: NATIONAL PAYMENT CARD SYSTEM JOINT STOCK COMPANY, Moscow (RU)

(72) Inventors: Evgenii Georgievich SOLOVEV, Moscow (RU); Aleksandr Aleksandrovich POLUDNITSIN, Korsakov (RU); Konstantin Vyacheslavovich POPOVICH, Moscow (RU); Ivan Denisovich SHILAKIN, Moscow (RU); Mariia Sergeevna AFANASEVA, Moscow (RU); Sergej Lvovich BARKOVSKII, Moscow (RU); Sviatoslav Vladimirovich KOROLEV, Moscow (RU); Aleksej Alekseevich PICHUGIN, Dubna (RU)

(21) Appl. No.: 19/117,300

(22) PCT Filed: Nov. 28, 2023
(86) PCT No.: PCT/RU2023/050276

§ 371 Date: Mar. 31, 2025

(30) Foreign Application Priority Data
Feb. 6, 2023 (RU) 2023102517

(51) Int. Cl. G06Q 50/18; G06Q 40/02; H04L 9/40; H04L 67/306

(52) U.S. Cl. CPC G06Q 50/188; G06Q 40/022; H04L 63/08; H04L 67/306

(57) ABSTRACT

The invention relates to IT within the finance industry, notably the automated systems, devices and methods for deal-making management and can be used for automated management of and control over deal-making. The automated system for deal-making management contains the centralized management device 1, at least two user's management devices with installed user interface and the service provider device 4. Each user's management device is connected to the centralized management device 1 via communication channels through at least one service provider device 4. The invention allows for the reduction of load on the automated system for deal-making management, as well as improves reliability and accelerates information processing when making deals.

### FIELD OF THE INVENTION

The invention relates to IT within the finance industry, notably the automated systems, devices and methods for deal-making management, and can be used for automated management of and control over deal-making, as well as arrangement of sales of goods and services.

### BACKGROUND OF THE INVENTION

Financial technologies are being rapidly developed, in particular the ones relating to cashless payments; overlay services are among those.

Overlay services are software and hardware services developed to improve various consumer-friendly payment services (for individuals and legal entities), as well as improve security, simplify deal-making and make it smooth. In financial industry, overlay services may precede a payment, follow a payment, as well as be used irrespectively of any payment. One of the overlay services is a deal support service described herein.

An invention known in the art describes a method and a computer system for conducting a business transaction between a consumer and a merchant: patent RU 2702085 C2 (cl. G06Q 20/00, 18.01.2016). The known method comprises initiating, by a consumer computer system, a transaction with a merchant, wherein consumer computer systems thereafter request an authoritative dynamic value at the central platform, receiving, by the consumer computer system, a payment account selection request from two or more consumer payment accounts from the central platform and receiving the selection by the computer system of the payment account consumer from two or more consumer payment accounts. Wherein the consumer computer system then receives authoritative dynamic value from the central platform, wherein the authoritative dynamic value corresponds to the primary account number (PAN) of the selected payment account. Wherein the business transaction is terminated using the authoritative dynamic value received by the merchant computer system. The computer system for conducting a business transaction between a consumer and a merchant is configured to implement the described method.

The disadvantages of the said method and computer system are the lack of functionality for control over the number of user's requests for documents related to business transactions (deals) and the inability to perform preliminary checks and prepare for a payment prior to the funds transfer, which result in a computer system overload and increase in transaction time and the likelihood of errors.

The closest analogous solution to the claimed automated system, device and method for deal-making management are the system, device and method described in patent RU 2581784 (cl. G06Q 20/00, 11.02.2011). The known automated system comprises a centralized management device and at least two user's management devices using communication channels to ensure access of the user's management device to the centralized management device via at least one service provider device, a user interface module configured to provide any user with access to the centralized management device. The known centralized management device (platform) has a centralized database configured to store information about user registrations, credentials and preferences, as well as means for automation of deal-making management. The known automated method comprises provision of access to the centralized management device for at least two users via communication channels via at least one service provider device; registration of a user, storage of access credentials of each user in the centralized database.

The disadvantages of this invention include provision of access to the invoice provision service via only one service provider, which significantly limits the service functionality, as well as inability to control the number of user's requests for deal-related documents, which result in the automated system overload and increase in transaction time. Another disadvantage is that it is not technically feasible to perform preliminary checks and prepare for a payment before the funds transfer using the said system and method, which may result in errors during transactions.

### DESCRIPTION OF THE INVENTION

This invention is aimed at improving reliability, quality and speed of electronic document management when making various deals through making a trackable deal and registering the fulfillment of obligations by parties including, without limitation, making business transactions.

The technical result of the claimed invention is the reduction of load on the automated system and the device for management of deal-making, improvement of reliability and speed of information processing when making deals.

Improvement of reliability of information processing shall be understood to mean provision of information security when exchanging messages in the automated system, making of secured transactions, reduction of the likelihood of errors during deals, registration of deal-making and reconciliation of outgoing and incoming deal-related information.

Load on the automated system and the device for management of deal-making is reduced through management of the number of requests for deal-related documents, support of the information exchange in the system via service providers, and synchronous/asynchronous implementations of information exchange. It is worth noting that reduction of load on the automated system for deal-making management also accelerates information processing when making deals.

The technical result is achieved due to the fact that the automated system for deal-making management contains a centralized management device configured to implement the deal support service and at least two user's management devices with installed user interface, using communication channels to ensure access of the user's management device to the centralized management device via at least one service provider device, wherein
the centralized management device is configured as a hardware and software system for automation of deal-making management and comprises an area of synchronous processing, a compatibility area, and an area of application processing for processing and logical control of information about deal-making from users,

Wherein, the centralized management device contains control means designed to limit the number of users' requests for deal-related information sent via communication channels to the centralized management device to a set number of times.

Being a particular embodiment, the system contains at least one user's bank management device configured to function as a service provider and connected to the centralized management device via communication channels.

The user's bank management device is connected to the centralized management device using communication channels via at least one service provider device.

Users' means of communication with installed user interface for indirect access (via a service provider) to the centralized management device are used as users' management devices.

The system contains at least one intermediary bank management device configured to function as a service provider and connected to the centralized management device via communication channels.

The intermediary bank management device is connected to the centralized management device using communication channels via at least one service provider device.

The system contains at least one controlling authority management device configured to function as a service provider and connected to the centralized management device via communication channels.

The controlling authority management device is connected to the centralized management device using communication channels via at least one service provider device.

The system for deal-making management contains at least one bank payment agent management device configured to function as a service provider and connected to the centralized management device via communication channels.

The bank payment agent management device is connected to the centralized management device using communication channels via at least one service provider device.

The system contains an operational clearing center management device connected to at least one user's bank management device and the intermediary bank management device via communication channels.

The centralized management device is configured to manage the user's profile.

Device of at least one service provider is configured to provide a user with an interface for registration, identification parameters check and user authentication, as well as for data storage by creating a new user account.

A hint generation module and a document provision module checking the number of hint use are used as means of control designed to limit the number of users' requests for deal-related information sent via communication channels to the centralized management device to a set number of times.

For the purpose of processing and logical control of deal-related information from users, the area of synchronous processing is configured to generate quick responses to user requests and their submission to the user, the compatibility area of the centralized management device is configured to queue deal-related requests, and the area of application processing of the centralized management device is configured to perform synchronous and asynchronous processing.

The centralized management device has a centralized database configured to store information about user registrations, credentials and preferences, as well as means of automation of deal-making management,
wherein, means of automation of deal-making management comprises
at least a means of deal-related documents receipt and submission to the user;
at least a means of deal-related documents publication;
at least a means of deal-related documents categorization;
at least a means of deal scenario generation.

Being a particular embodiment, the means of documents receipt and submission contains a document management module, a document provision module, a module of guaranteed delivery of notifications and download links (a store and forward module), a hint generation module and a queue manager module.

The means of deal-related documents publication contains a user profile module and a service subscription module.

The means of deal scenario generation contains an agreement module, a transfer and acceptance certificate module, an invoice module, a module for payer's bank statement of debiting, a module for payee's bank statement of crediting, a template module, a verdict module, a redirection module, a claim module and a report generation module.

The means of deals classification contains a document reconciliation module.

All modules included in the means of deal-related documents publication, the means of deal scenario generation, and the means of deals classification contain filters configured to match documents related to deals and contained in the queue manager module with each other.

The centralized database consists of databases of all modules of the centralized management device, forming a single network via communication channels.

The document management module is configured to perform parsing and validation.

The means of deal-related documents publication is configured to publish full information about deal-making in the automated system for the first time and share a link to the previously published information.

The means of deal-related documents publication is configured to receive and provide information about deals at user requests through the use of a unique hint.

The means of deal-related documents publication is configured to generate reports on deals and provide them to users.

The centralized database comprises unique identifiers relevant to each user and at least one user's service provider.

The automated method for deal-making management comprising provision of access to the centralized management device for at least two users via communication channels via at least one service provider device; registration of a user, storage of access credentials of each user in the centralized database,
the method comprising:
creating user account;
providing each user with access to one or at least two service providers at the same time;
via user's service provider, performing user authentication, publishing a deal-related document on the network of the automated system for deal-making management;
generating user request for making a deal on a user's management device;
categorizing the incoming information on the centralized management device via the means of deals classification;
generating a deal on the centralized management device the centralized database of which stores deal scenario templates for approval, confirmation and making of various deals;
registering, comparing and tracking deal-related agreements;
via hints, controlling the number of requests for deal-related documents received through communication channels and access of a user's device to the deal-related information.

In particular embodiments, posting of a user account and deal-related information on the centralized management device after the user's authorization check by the user's service provider device.

Storing data on user preferences in the centralized database of the centralized management device.

Generating of a unique identifier for each deal and for each document in the centralized management device.

Providing access to deal-related information at user request.

Providing user with a means of account editing in the centralized management

Matching documents related to deals and contained in the queue manager module with each other using filters of modules contained in means of deal-related documents publication, means of deal scenario generation, and means of deals classification.

Making secured transactions after the controlling authority management device confirms compliance with deal conditions.

### Terms

The deal support service (automated system) is an overlay service used for invoicing and making e-payments of such invoices, which is aimed at workflow standardization and acceleration, provision of electronic delivery of invoices (payment orders with acceptance) from a payee to a payer, preparation of a payment; it is also a mechanism for digitization of workflow between users (economic actors). In particular, agreements, acceptance certificates, invoices with amount payable (sales receipts or reporting documents), payer's bank statements of debiting, payee's bank statements of crediting, verdicts of controlling authorities, statements from a collateral bank, delivery notes (documents a vendor provides to a buyer when delivering goods) can be used as documents confirming deal-making by users. This list is not limiting and provided as an example.

The deal, as used herein, is actions of users, in particular, individuals and legal entities, as well as government authorities, aimed at establishment, change or termination of civil rights and obligations. The deal between users is registered in the deal support service (automated system) for electronic management.

The information about deal-making is information about a deal comprising a user request for making the deal and notifications about all its stages (notifications of publication on the network of the deal support service, confirmed payment advices, etc.).

The user (individual, legal entity or a government authority) is an information exchange subject in the deal support service, who uses their management device to interact with the user's service provider device and user's bank. The user can be an initiator or a recipient of a deal-making process, as well as a payer or a payee in terms of invoices and payments.

User's bank is an information exchange subject in the deal support service, a financial institution providing electronic access to user's bank accounts and supporting payments, in particular, during interaction with the operational and payment clearing center (OPCC).

The user's (payer or payee) management device is a personal communication device used to manage deals in the automated system both for information exchange and payment purposes. Devices with the user interface enabling deal management, as well as data exchange and receipt of information about deal-making (workflow) and/or payment transactions can be used as the payer's management device or the payee's management device. Users' means of communication with installed user interface, in particular, a mobile phone, a tablet, a personal computer, a terminal or an ATM can be used as users' management devices. What these devices have in common is the need for the user to be preliminarily authenticated by their bank in the interface of such device.

The payer is an information exchange subject in the deal support service, who uses their management device to directly interact with the service provider device and the management device of their bank, configured to function as a service provide for the purpose of requesting for and receiving of soft-copy documents, e.g. agreements, certificates, invoices, resolutions on documents sent to the payer, as well as initiating payments in favor of payees. Individuals, legal entities and government authorities can be payers.

If a user is the payer, the bank used for the payment is called the payer's bank and a service provider of such user is called the payer's service provider.

The payee is an information exchange subject in the deal support service, who uses their management device to initiate electronic invoicing (issuing of payment orders with acceptance) via the payee's service provider and awaiting crediting of funds to the payee's bank account in the payee's bank against issued invoices. Any individuals and legal entities, as well as any institutions including government authorities can be payees.

Individuals can be understood to mean, including, but not limited to: buyers of goods, works or services, sole proprietors, private persons and self-employed persons.

Legal entities can be understood to mean, including, but not limited to: trading companies, telecommunication companies, utility service providers, condominium associations, gardeners' non-commercial partnerships, consumer cooperative for dacha construction, etc.

If a user is the payee, the bank used for the payment receipt is called the payee's bank and a service provider of such user is called the payee's service provider.

Any deal between users, including a purchase or payment for the services, does not require agreement signing each time, still it is inherently an agreement. Users, in particular, the payer and the payee (the initiator and the recipient) make a decision: one party decides to sell something at a certain price or to render a service, and another party decides to pay for the service or to buy something at a certain price. One process implies preparation of only one accompanying document, e.g. a fiscal sales receipt.

The payer's bank management device is at least one computing device of a credit institution serving the payer, as defined by the standards, from whose correspondent account funds must be debited when transferring funds by order of the payer.

The payee's bank management device is at least, one computing device of a credit organization serving the payee, as defined by the standards, to whose correspondent account funds must be credited when transferring funds in favor of the payee.

The user's service provider device is a software and hardware system comprising at least one server for the user information exchange in the deal support service and provision of access for e-services of the said service, in particular: access to an account, report on the activity in the deal support service, means of creation, editing, publishing, and delivery of deal-related documents and subscription to such documents, provision of user's profile data to subscription participants (those who were subscribed for), payments initiation, user notifications. Each user's service provider device is configured to provide a user with an interface for registration, verification of identification parameters, and user authentication, as well as data storage through creation of a new user account, which results in the reduction of load on the automated system and the device for deal-making management.

The software and hardware system of each bank (user bank, intermediary bank, bank payment agent) and a controlling authority of the automated system for deal-making management can additionally function as a service provider, if it is additionally supplemented with custom equipment and specially configured software. Thus, as a result of the foregoing, user's bank management devices, in particular, the payer's bank management device and the payee's bank management device, the intermediary bank management device, the bank payment agent management device and the controlling authority management device are configured to function as a service provider.

The centralized management device (CMD) is a software and hardware system comprising servers that ensure operation of the system and application software of the deal support service. Each server is designed as a computing system comprising means of automation of deal-making management and their modules.

The module is a certain software component. The set of modules defines the operation of CMD hardware and software system. The number of same-type modules depends on the CMD load capability: the higher requirements to the CMD load are, the more same-type modules operating simultaneously may be required. The number of different-type modules depends on the variety of purposes for which agreements are signed (e.g. sale and purchase agreements, service agreements, joint operation agreements, custody agreements, insurance agreements, etc.) using CMD.

A combination of software and hardware systems including user's management devices, user's bank management devices, service provider devices, the centralized management device, the intermediary bank management device, the controlling authority management device, the bank payment agent management device, and the operational clearing center management device is the automated system for deal-making management.

The process is a sequence of actions aimed at creation and editing of deal-related documents (agreements, certificates, invoices, statements, etc.) in the automated system for management of deals made as a result of information flows.

The information flow is a certain sequence of messages exchanged by users in the automated system for management of deal-making, the processing of which results in establishment, modification or termination of legal relations of legal entities, individuals, or government authorities (creation or modification of one certain document or receipt of information about such document).

Messages are elementary units of information flows transferring the content of deal-related documents (payload). Management devices of individuals, legal entities, and government authorities exchange electronic messages forming one logical unit to receive data on the deal including information about the user (in particular, the payer, the payer's bank, the payee, the payee's bank, the payment system, the intermediary bank, the transaction amount and fees collected by system users in case of a funds transfer).

If all messages forming the information flow are exchanged exclusively between the user and its service provider, such information flow is considered to be local, i.e. the centralized management device does not participate in it. This information flow is formed outside the automated system for deal-making management.

Data elements are elementary units of messages, forming a block inside the message.

The block is a fragment of the deal-related document, comprised of a set of data elements, which is (fully) created within one process as an integral part of the document and can be used as a reference to such fragment within one or more subsequent processes during which other documents are created. At least two blocks are grouped in a data block.

The scenario is a certain sequence of planned services (deliveries) and/or deal-related processes (documents). The scenario or the agreement can be preliminarily planned, prior to signing the agreement or agreements; i.e. a template of the scenario can be included in agreements executed using such scenario or use a template of the entire agreement. In general, the scenario does not belong to one agreement. It is possible to create the scenario to be used for different agreements or included in one agreement.

Process triggers are CMD parameters influencing the selection of certain information flows to be used for the certain process that forms documents accompanying deal-making.

Framework of the automated system for deal-making management shows all the links between key system components: processes, deal-related documents, users and information flows. The framework sets the rules for information flows use depending on the processes.

The protocol of the automated system for deal-making management is a set of rules and technical procedures that enables several users (from two to the required number) to exchange messages using their management devices joined in a network of the automated system for deal-making management. The protocol covers all interactions taking place in the automated system:
processes and relevant deal-related documents;
information flows forming each process;
triggers defining rules of the information flows use for a certain process;
a framework linking users' management devices, processes, deal-related documents and information flows;
messages forming information flows;
blocks forming messages;
data elements, elementary units of blocks.

The user profile in CMD (profile) is a set of data identifying a user and its preferences. The user profile management process means creation, updating or removal of a user profile, in particular, addition, change or deletion of bank details.

The controlling authority is a user (institution) confirming compliance with conditions of a deal (delivering a verdict) by a payer and a payee, as well as compliance with laws, in order to ensure that the payer receives goods or services specified in an agreement and the payee receives funds according to the agreement for the delivered goods or services. A collateral bank acts as the executor of the financial security conditions. For secured transactions, the controlling authority uses the automated system for deal-making management to inform the collateral bank (via a verdict) that the payee (a vendor or a service provider) has met conditions of the deal and payer's money can be transferred to it.

The verdict is a conclusion of the controlling authority regarding the conditions of the deal.

Both government authorities and legal entities (private organizations) authorized by the parties (users) making the deal and registered (accredited) by the centralized management device can act as the controlling authority.

The following agencies may act as government authorities: the Federal Service for State Registration, Cadastre and Cartography (Rosreestr), the State Inspectorate for Traffic Security (GIBDD), the Federal Tax Service (FTS), the Federal Financial Monitoring Service (Rosfinmonitoring), and Russian Post. This list is not limiting and provided as an example.

Legal entities (authorized organizations) may include, for example, commercial postal operators or commercial quality controllers.

The controlling authority management device (CAMD) is at least one computing device of the controlling authority, configured to confirm the users' (payer's and payee's) compliance with conditions of the deal.

The bank payment agent (BPA) is an information exchange subject in the automated system for deal-making management (the deal support service), in particular, a legal entity that ensures transfer of funds from payers to payees. The following enterprises may act as BPA in terms of invoices and their payment:
trade enterprises;
service enterprises.

The bank payment agent's management device (BPAD) is a management device of an organization that ensures transfer of funds from payers to payees.

The intermediary bank (IB) is an information exchange subject in the automated system for deal-making management, acting as an intermediary in settlements, which accumulates funds received from payers for a certain period of time and, after receiving a relevant order (from BPA or as a result of a verdict of the controlling authority), transfers funds to the payee's account (in particular, after the performance of a secured transaction, about which the system notifies the controlling authority) or to the payees' accounts (after receiving a register for the transfer of funds from the automated system for deal-making management based on data from BPA).

The intermediary bank may act as:
a collateral bank—in secure transactions involving a controlling authority;
a BPA bank—when paying invoices via BPA.

The intermediary bank management device (IBMD) is a hardware and software management system of the organization that accumulates funds received from a payer for a certain period of time and, after receiving a relevant order, transfers funds to the payee's account. If additionally supplemented with custom equipment and specially configured software, IBMD can act as the intermediary bank service provider.

The operational clearing center management device is at least one computing device configured to support transfer of funds between management devices of users' banks and process orders for the transfer of funds to the settlement system, as well as receive authorization requests from management devices of BPA banks and route such requests for authorization to the payers' banks, receive responses and return such responses to BPA banks, receive payment orders and send such orders for clearing, form net positions and send such net positions to the settlement system, as well as send reports to the users' banks and BPA banks.

The hint is an identifier generated in the CMD hint generation module, which is a sequence of letters and numbers submitted by the user's service provider in a request to CMD to control the number of user's requests for a document sent to CMD via communication channels.

The number of requests allowed by the hint is determined by the category the user belongs to. A set of user categorization parameters is used to determine the user category.

Logical categorization of users in CMD is carried out based on the categorization parameters specified for the recipient and stored in the centralized database in the form of recipients' configurable profiles. Recipients' configurable profiles are a means of user categorization. Recipients (users) have a right to request the parameters from CMD (possibly on a commercial basis), according to which users are categorized. The number of requests allowed by a hint is also specified in the recipients' configurable profiles in CMD for each user category. Thus, at least two user categories are determined, after which this data is transferred to the hint generation module.

### BRIEF DESCRIPTION OF THE DRAWINGS

This invention is exemplified by the following figures.

FIG. 1 depicts a framework of the automated system for deal-making management.

FIG. 2 depicts a flowchart of the automated system for deal-making management.

FIG. 3 depicts a structural diagram of the centralized management device (CMD)

FIG. 4 depicts a structural diagram of the CMD application processing area.

FIG. 5 depicts a flowchart of a process that consists of information flows in the automated system for deal-making management.

FIG. 6 depicts an example of a deal between users (payers and payees) involving an operational payment clearing center (OPCC).

FIG. 7 depicts an example of a scenario template for one agreement.

FIG. 8 depicts an example of a scenario template for a set of related agreements.

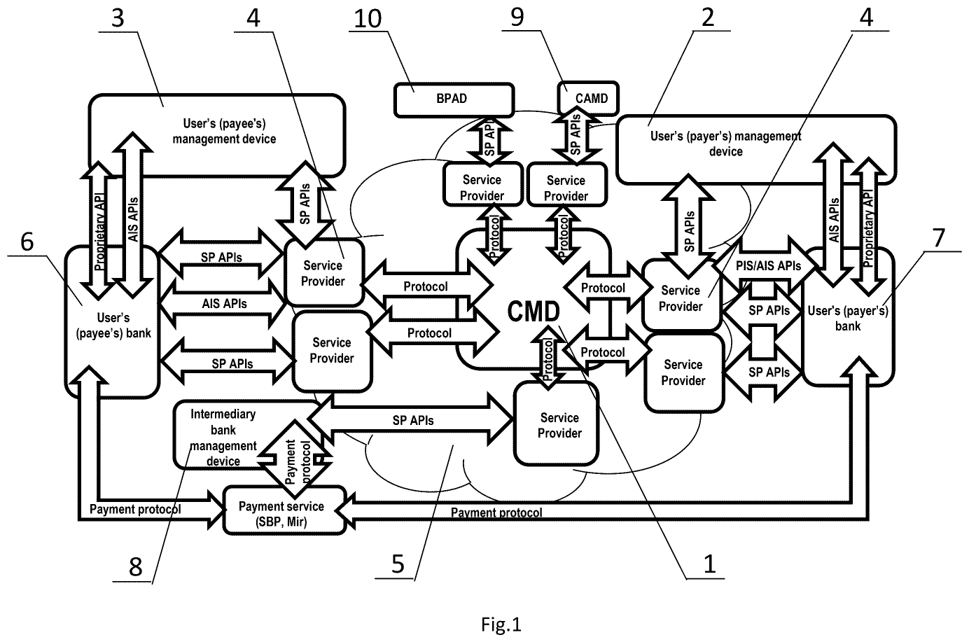

The automated system for deal-making management (FIG. 1) is a distributed or “cloud computing system” for managing deals.

The automated system for deal-making management contains CMD 1, at least two user's management devices (payer's management device 2 and payee's management device) with installed user interface and devices of service providers 4. Each user's management device is connected to CMD 1 via communication channels through at least one service provider device 4. CMD 1 and devices of service providers 4 form a network of the automated system for deal-making management 5 within which all devices of service providers 4 interact with each other only via CMD 1 being the only central counterparty. CMD 1 manages identification of service providers and interaction of all service providers 4 via CMD in all deal-making processes (scenarios, information flows). Identification management by CMD means, in particular, registration and issue of unique identifiers to service providers of users' banks, intermediary banks, bank payment agents and controlling authorities and storage of these identifiers in a centralized database, as well as publication of these identifiers on the network of the automated system for deal-making management.

Users' means of communication with installed user interface for access to the service provider device can be used as the user's management device. A smartphone, a tablet, a smart watch, a computer (including a portable one), a TV set-top box, the technical characteristics of which allow installing a user interface (application) to access CMD and having access to the Internet for the payment services use, and to personal accounts in the bank (for online servicing) can be used as users' means of communication. The above list is not limiting.

Depending on the deal scenario, the automated system for deal-making management may also include: at least one user's bank management device (payee's bank management device 6 or payer's bank management device 7), the intermediary bank management device (IBMD) 8, the controlling authority management device (CAMD) 9 and the bank payment agent management device (BPAD) 10.

CMD is a key architectural component of the automated system for deal-making management which may have from two to any number of user's management devices, depending on the technical characteristics of the automated system for deal-making management. At the same time, CMD is configured to manage a user profile, which implies creation, updating or deletion of the user profile, in particular, adding, changing or deleting bank details.

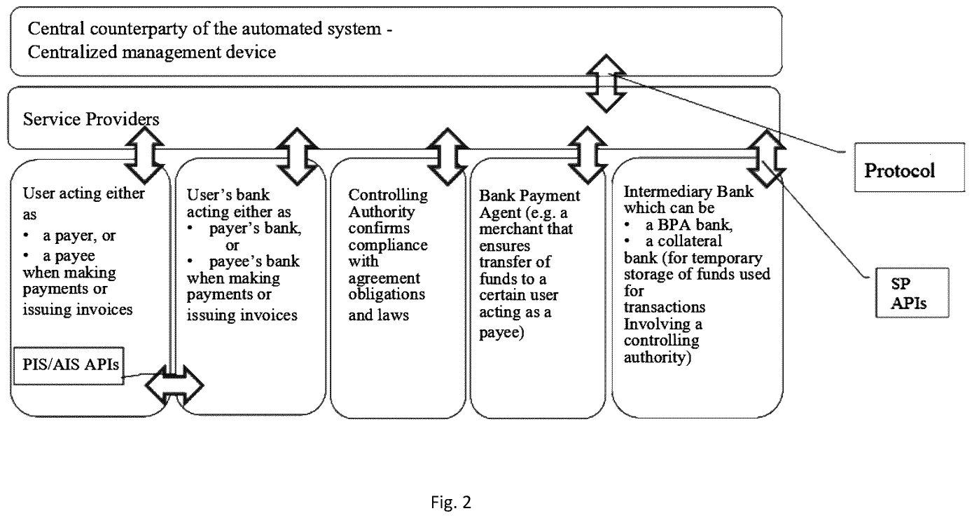

FIG. 2 depicts a flowchart of the automated system for deal-making management with its main users and interactions.

All interactions that occur in this system are regulated by the protocol, in particular:
processes and relevant deal-related documents and their users (payers and payees, initiators and recipients);
information flows forming each process;
triggers defining rules of information flows use for a certain process;
a framework linking users (participants), processes, deal-related documents, triggers and information flows;
messages forming information flows;
blocks forming messages;
data elements, i.e. elementary units of blocks.

In addition to the protocol of the automated system for deal-making management, users use other protocols or communication languages to interact with each other including (FIG. 1):
payment protocol,
service provider API,
proprietary API protocols,
PIS/AIS APIs protocols.

API (application programming interface) is an interface (language) for programs interaction with each other.

The payment protocol covers the users' interaction, in particular, banks and payment services (e.g., such as Mir Payment System, the Bank of Russia service, the Faster Payments System service, standard payment orders processed by CSC of the Bank of Russia), to perform actual fund transfers between users and their banks. The above list is not limiting.

The user directly interacts via their management device with at least:
their service provider, e.g., via service provider's APIs to initiate information flows resulting in a specific deal-related document;
with the user's bank management device, e.g., via a proprietary protocol (through the bank's channels).

Service provider's APIs (SP APIs) shown in FIG. 2 cover the service providers' interaction with users to initiate deals, in particular, payments and requests for information on deal statuses, in particular, states of accounts.

PIS/AIS APIs (payment initiation service/account information service) are services for initiating payments or providing account information, used to initiate payments and to provide information about a bank account if the user's service provider and the user's bank roles belong to different entities. Otherwise, the service provider and the bank are the same entity, and such interactions are implemented locally within one entity and do not require PIS/AIS APIs use.

To make any changes in the network of the deal support service, all users interact exclusively with the users' service provider devices via SP APIs (FIG. 2).

The user acting as a payer initiates a deal-making process by sending a request for the deal to other users (in particular, the payee/user bank/controlling authority/bank payment agent/intermediary bank).

The above list is not limiting and may include other devices that perform functions of the above-mentioned users.

Based on the legal status of the user and the relevant legal regulation of the automated system, as payees and payers (initiators and recipients) when making deals with subsequent initiation of invoices (charges) issue and performance of payments corresponding to the issued invoices (charges), deals can be classified as:
B2B—Business to Business;
C2B—Consumer to Business;
P2P—Person to Person, C2C-Consumer to Consumer;
B2G—Business to Government;
C2G—Consumer to Government.

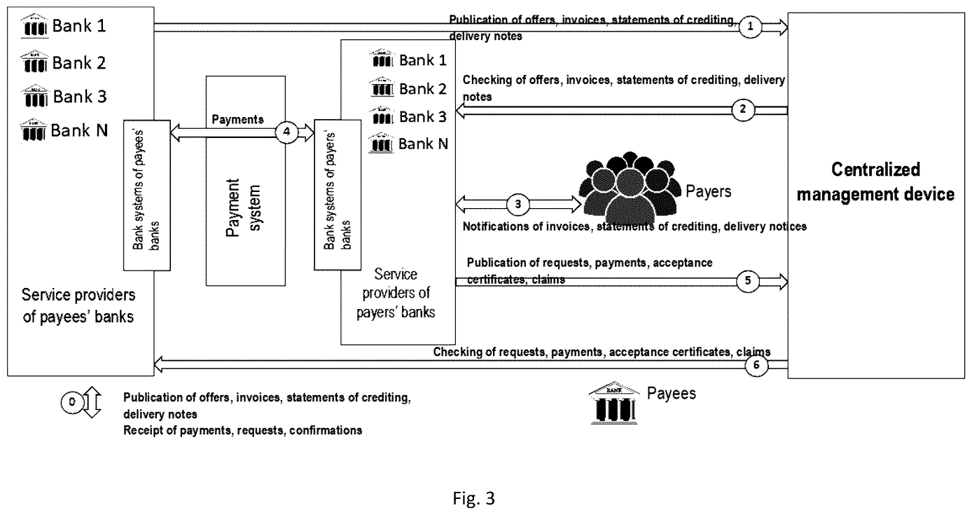

The centralized management device (FIG. 3) is configured as a software and hardware system containing the centralized database for storing information about user registration, credentials and preferences; means of documents receipt and submission; means of deal-related documents publication; means of deals classification and means of deal scenario generation.

CMD has the following areas: an area of synchronous processing 11, a compatibility area 12 and an area of application processing 13. The processes 18 carried out in the specified areas (11-13) allow for the processing and logical control of information on the deal-making, received from service providers.

The proposed CMD architecture ensures system operation both with the use of the “subscription-delivery” asynchronous message exchange template and the “request-response” synchronous message exchange template.

The area of synchronous processing 11 contains control means designed to limit the number of user's requests for deal-related information, configured as a hint generation module 30 and a document provision module 15 corresponding to servers operating synchronously, for example, but not limited to, web servers. In the area of synchronous processing, requests/messages are received, checked and processed in real time: the system performs parsing, authorization, authentication of service providers, validation, logging, translation into an internal representation and transfer to the compatibility area, checking the hint provided by the service provider, generating a quick response and sending it to the sender.

The area of synchronous processing 11 contains means of documents receipt and submission comprising:
the document management module 14—a module configured to receive a message, extract information from it, validate the sender and transfer it for processing (registry),
the document provision module 15—a module configured to provide the requested information in response to the request containing a hint, having first checked the said hint;
the module of guaranteed delivery of notifications and download links (the store and forward module) 16—a module configured to notify CMD that the document has been prepared and is ready to be sent to the receiver,
the hint generation module 30.

The document management module 14, the document provision module 15, the module of guaranteed delivery of notifications and download links (the store and forward module) 16, the hint generation module 30 and the queue manager module 31 of the compatibility area 12 form means of documents receipt and submission.

The compatibility area 12 corresponds to the server operating as a message queue manager (the queue manager module 31) and providing a two-way communication channel between the area of synchronous processing 11 and the area of application processing 13. The compatibility area 12 (a two-way communication channel) is a kind of buffer implementing the asynchronous communication pattern between the area of synchronous processing and the area of application processing. In the compatibility zone, messages translated into an internal representation are received and then placed in a queue, from which they will be extracted for application processing by software modules of the area of application processing 13. For each message, software modules of this area will implement the following delivery principles (these principles are usually called policies):
Durability policies-time of message delivery to processing modules;
Security policies-setting specific modules that have access to specific messages in the queue;
Message deletion policies-setting criteria for deleting messages from the queue;
Delivery policies-ensuring guaranteed delivery of messages to processing modules;
Routing policies-setting the location of processing modules for delivering messages from the queue to such modules;
Batch processing policies-setting the possibility of transferring several messages for processing at once to the processing module.
Queuing policies-setting the time of queuing.
Receipt notification policies-ensuring that notifications of the message delivery to the processing module 13 are delivered to the document management module 14.

The area of application processing 13 (synchronous/asynchronous) processing includes processing of user requests for deal-making both at the time of their receipt (synchronously) and in offline (batch) mode (asynchronously), which determines the area architecture and allocation of functions.

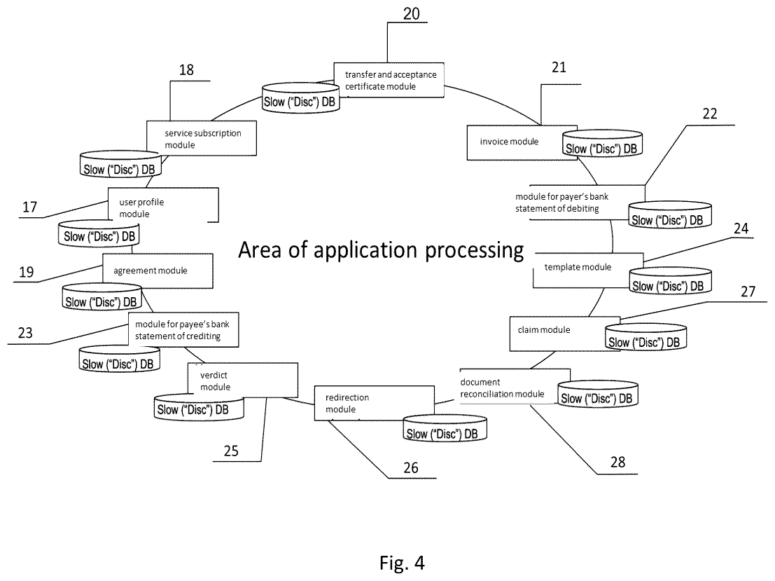

CMD area of application processing (FIG. 3 and FIG. 4) comprises at least a means of deal-related documents publication; at least a means of deals classification and at least a means of deal scenario generation.

Means of deal-related documents publication (FIG. 4) comprises:
a user profile module 17—a module configured to register each automated system user and keep user information up-to-date ;
service subscription module 18-a module configured to register subscriptions to notifications of user-payers for documents from certain user-payees and notifying the latter thereof.

Thus, means of deal-related documents publication is configured to:
register and keep up-to-date information about each user of the automated system;
publish full information about deal-making in the automated system for deal-making management for the first time and share a link to the previously published information.
extract and provide information about deals at user requests;
generate reports on deals and provide them to users.

Means of deal scenario generation combines different documents within one deal and contains modules for processing of deal-related documents and relevant databases, in particular, but not limited to the following:
agreement module 19—a module configured to register and compare agreements, and check whether an agreement is included in a specific scenario;
transfer and acceptance certificate module 20—a module that registers an acceptance certificate and matches it with the agreement it may be included in;
invoice module 21—a module that registers an invoice and matches it with the agreement it may be included in;
module for payer's bank statement of debiting 22—a module that registers statements from the payer's bank of funds debiting and matches them with the invoice, generates notifications for recipients and prepares them for sending to recipients;
module for payee's bank statement of crediting 23—a module that registers statements from the payee's bank of funds crediting and matches them with the previous invoice;
template module 24—a module that registers published templates;
verdict module 25—a module that receives, stores and matches a verdict with the issued invoice and the relevant statements of funds debiting and crediting;
redirection module 26—a module that receives a request for invoices redirection and registers it;
claim module 27—a module that registers a claim and matches it with the agreement or certificate to which it relates,
report generation module 29—a module that generates reports on deals.

All modules inform the queue manager module 31 about the performance for subsequent transfer of this data to the module of guaranteed delivery of notifications (the store and forward module) 16 and the document provision module 15.

Means of deals classification consists of the following modules:
document reconciliation module 28 that provides information on incoming and outgoing business (commercial) activity of users, as well as modules that process other types of documents that are organizational and administrative, financial, accounting and reporting and statistical documents (not shown in FIG. 4).

Reconciliation mechanism means tracking the account state and its changes based on the processing of statements of debiting (statements of crediting) received by the system, from the status “not paid”/“fully or partially paid” to the status “payment made”/“payment received” and further to the technical reconciliation processes. The reconciliation mechanism is implemented by the reconciliation module for deal-related documents 28, and is intended to control the payment status and, therefore, improve reliability of deals.

Each of the above modules 15-31 has its own database. The centralized database consists of the databases of all modules 15-31 of CMD forming a single network via communication channels.

All modules of the area of application processing 13 included in means of deal-related documents publication; means of deal scenario generation and means of deals classification contain filters that match the type of document located in the queue manager module 31 from the compatibility area 12 with the type of document set in the filter, and extract only those messages the document type of which matches the setting of its filter.

The centralized database comprises unique identifiers corresponding to each user and their service provider. In particular, users are understood to be payers, payees, the user's bank (the payer's bank, the payee's bank), the controlling authority, the bank payment agent, the intermediary bank, etc.

The CMD 1 synchronous operation is used for the cases when CMD 1 can complete processing in a relatively short time during which it is advisable to maintain communication.

The CMD 1 asynchronous operation is used for the cases when CMD 1 cannot complete processing in a relatively short time during which it is advisable to maintain communication.

The above implementation of the automated system for deal-making management and the centralized management device allows reducing the load on the automated system, accelerating information processing and reducing the likelihood of failures when making deals. In particular, acceleration of processing and sending notifications when having e-workflow is achieved due to:
subscriptions of users (recipients or payees) to documents from certain users (initiators or payers),
notifications of users (recipients or payees) about documents for them from other users (initiators or payers),
management of the number of requests for documents by using a hint,
use of a network of providers, as well as
use of synchronous/asynchronous information exchange implementations in the automated system.

The automated system for deal-making management works as follows (FIG. 1).

In order to become a system user, the user (the payer or the initiator) needs to create an account and generate a request for the deal using their management device 2. To do so, the user must install and launch the relevant application provided by their service provider 4 or go to the service provider's website; as a result, the user sees an interface suggesting either authorization or registration. Each user is granted the right to access several service providers simultaneously.

If the user selects registration, then the service provider 4 shows the user an interface for registration with all the fields to be filled in (organization's short or full name, telephone number, email, TIN, location or registration address, bank name, account number, etc.). After this, the service provider 4 checks whether the user is already registered in the automated system for deal-making management. To do so, it checks all the basic identification parameters of the user (payer), such as phone number, email, TIN, etc. for uniqueness in its system.

If all basic identification parameters are unique, the service provider device checks whether they really belong to the user (the user is authenticated). For this purpose, text messages, push messages or notifications in instant messengers, a call, an email with an authentication link, etc. can be used. To confirm authenticity of the user, their service provider can also contact the user's bank. The service provider device is configured to perform other additional user checks at service provider's discretion. After successful registration and authentication, the service provider stores the data by creating a new user account.

The user can use various means to change their account in CMD, including various functions of the application or website of the service provider device; the user can edit and delete their account, and also receive data directly from the Unified System of Identification and Authentication of the Russian Federation or other similar systems for the account transfer to the service provider. In particular, the user can add new or change existing bank accounts, new phone numbers or emails, as well as edit any other information at the discretion of the service provider device.

If the user wants to change the account parameters, the service provider device 4 shows a user interface for making changes to the account parameters and confirms the changes. The service provider device 4 is configured to check whether these changes are actually made by the user. After verification, the user's service provider device 4 stores the new data by updating the user account. Through the user's management device 2, the user (payer) is notified that the account was successfully updated and is redirected to the main page of the application or website of the device of their service provider 4.

After providing the user (payer) with access to CMD 1 through the service provider device 4, the user (payer) generates a request for the deal on their management device 2, which is sent to CMD 1 via communication channels. After that, for the purpose of deal-related data tracking, a deal-related document is published on the network of the automated system for deal-making management 5. Through module 15, the user's service provider device 4 receives notification of deal-related data publication.

The published document related to the deal remains on the network 5 until a final status (for example, a “paid in full” status for an invoice) is set to it or the deal has expired and its current status is not final (for example, “finally delivered”).

Next, we will consider the processes occurring in CMD (FIG. 3). The document management module 14 of the area of synchronous processing 11 of CMD receives a request for the deal and extracts deal-related information from this request, validates the user (payer) and processes requests for the deal. For example, deal-related information may include: parties of the deal, subject, conditions, specifications, delivery schedule. For each deal and for each document, CMD generates a unique identifier (URL) with the help of which users can access deal-related information or document upon request.

In compatibility area 12, the queue manager module 31 converts incoming requests for the deal and queues them up. Requests for the deal will be retrieved from the above-mentioned queue for application processing by software modules of the area of application processing 13.

After that, in the area of application processing 13 (FIG. 4), the document reconciliation module 28 providing information on incoming and outgoing business (commercial) activity of users categorizes the incoming information. The agreement module 19 registers and compares agreements, as well as checks the inclusion of each deal-related agreement in a certain scenario. The transfer and acceptance certificate module 20 registers the acceptance certificates and matches them with the agreement they may be included in. The invoice module 21 registers invoices and matches them with the agreement they may be included in. The module for payer's bank statements of debiting 22 registers statements from the payer's bank of funds debiting and matches them with the invoice, then generates notifications for users (payees) and prepares them for sending to users. The module for payee's bank statement of crediting 23 registers statements from the payee's bank of funds crediting and matches them with the previous invoice. The template module 24 registers published templates.

A deal-related template of scenario or agreement may be stored on the network of the automated system for deal-making management and may be provided upon user's request. Any user's service provider device can publish a deal-related document template in CMD. Any user's service provider can request from CMD both a set of deal-related document templates and a specific template.

The verdict module 25 stores and matches a verdict with the issued invoice and the relevant statements of funds debiting and crediting. The redirection module 26 receives a request for invoices redirection and registers it. In case of a claim from the user (both the payer and the payee), the claim module 27 registers the claim and matches it with the deal-related agreement or certificate to which it relates. All modules send the progress status to the queue manager module 31 via communication channels for subsequent transfer of this data to the module of guaranteed delivery of notifications (store and forward module) 16 and the document provision module 15.

The module of guaranteed delivery of notifications (store and forward module) 16 receives from the hint generation module 30 its value to be added to the notification. The module of guaranteed delivery of notifications (store and forward module) 16 informs the user (payer) via the user's management device that documents (in particular, invoices, statements, etc.) are prepared and ready to be sent and provide a hint.

Means of deal scenario generation combines different documents and deals within the framework of one deal. The CMD centralized database stores information about templates of deal scenarios and relevant preliminarily prepared deal-related agreements.

Users (payers) receive invoices (payment orders, charges) to pay for purchases, services (commercial and government) and other e-payments, and also initiate payment of the received invoices. E-payment of the invoice completes the process, allowing the payer to make a payment remotely and eliminating the need to manually enter account details to generate payment orders, as well as eliminating the need for a physical medium-paper.

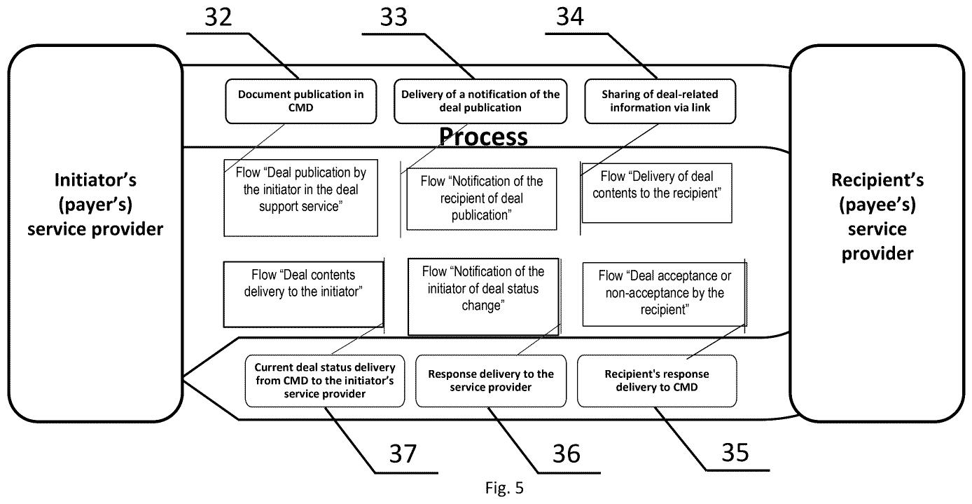

Below are the processes occurring in the automated system for deal-making management (FIG. 5).

“Document publication in CMD” 32 takes place through the information flow on the network of the automated system for deal-making management; after that information flow “Delivery of notification of deal publication” 33 containing a hint is used and the notification is delivered to the payee's (recipient's) service provider device. Using the link received by the payee as part of information flow “Deal contents delivery to the recipient” 34, the user (payee) can obtain deal-related information stored in CMD using the previously received hint. The payee makes a decision to agree to or refuse from the deal within information flow “Recipient's response delivery to CMD” 35. Next, the response is delivered to the payee's service provider within information flow “Recipient's response delivery to the service provider” 36, as well as to the payer's service provider within information flow “Current deal status delivery from CMD to the initiator's service provider” 37.

The process of concluding a deal-related agreement is only required if the deal parties have decided to enter into the agreement. If the user, as the payee, immediately issues an invoice to the payer for payment, without first concluding the agreement, a process that does not require entering into the agreement is applied.

Deals made in the said automated system can be categorized into “unsecured deals” and “secured deals” (secure), which require compliance confirmation by a controlling authority.

Within the processes occurring in the automated system for deal-making management, the user, as the payer, using their management device, can:
appoint/accept payees (that is, suppliers of goods, works or services), in particular, subscribe to the delivery of invoices from payees identified by the payer;
receive, accept or reject deal-related documents published for such user (e.g. agreements, acceptance certificates, invoices, recipient's bank statements of crediting, as well as, potential refunds, reconciliation reports, etc.);
request a deferment and/or payment in installments;
express consent to direct debiting of the payer's bank account against the received invoice;
accept the invoice for subsequent payment;
accept the invoice for instant payment alongside with payment initiation;
request reconciliation reports.

Using the management device, the user as the payer interacts with:
the payer's service provider device (directly via the SP APIs protocol);
the payer's bank management device (directly or via the payer's service provider device);
the payee's management device (either outside the network of the automated system for deal-making management, or indirectly via the payer's service provider device connected to the network).

Using the management device, the user as the payee can:
request their activation/subscription by payers;
receive profile data (proxy) of payers who have subscribed for documents from them,
publish documents (agreements, certificates, invoices, statements of crediting) for payers who have subscribed to them;
issue invoices to specific payers or “to bearer” (without specifying payers);
agree on the terms of the deferment at the request of the payer;
agree on payments in installments at the payer's request;
request the status of issued invoices according to specified conditions;
request reports and reconciliations against their invoices according to specified conditions.

Using the management device, the user acting as the payee interacts with:
the payee's service provider device;
the payee's bank management device (directly or via the payee's service provider device);
the payer's management device (either outside the network of the automated system for deal-making management, or indirectly via the payer's service provider connected to the network).

For the user acting as the payer, the payer's bank provides via its management device:
remote access to the payer's bank accounts for cashless payment of invoices (payment orders) issued to them;
execution of payments initiated by the payer through its management device, either directly or via their service provider;
strict authentication of the payer;
validation of payer's subscriptions;
execution of payments by orders of the payer initiated via their service provider;
execution of payments by payment orders initiated by the payer's service provider, (direct debiting) from the payer's accounts, based on the payer's authorized subscriptions;
informing the payer's service provider about payments made.

Using the management device, the payer's bank interacts with:
the payer's management device (directly or via the payer's service provider using SP APIs);
the payer's service provider device (via PIS/AIS APIs);
payment systems or services outside the proposed automated system for management of deal-making.

For the user acting as the payee, the payee's bank provides via its management device:
acceptance and crediting to the payee's bank account of funds paid against invoices issued by the payee; 28
verification (validation) of the payee's accounts;
generation of statements, confirmations, as well as other reports and notifications for the payee;
verification of the payee by sending a request to controlling authorities and receiving a response to the request.

Using the management device, the payee's bank interacts with:
the payee's management device (directly or via the payee's service provider device using SP APIs);
the payee's service provider device (via PIS/AIS APIs);
payment systems/services (outside the proposed system).

As the controlling authority, the user interacts via the management device with:
the service provider's device (directly);
CMD (indirectly via the service provider device connected to the network of the automated system for deal-making management);
the management device of the collateral bank (indirectly via the device of the service provider connected to the network of the automated system for deal-making management);
the payee's management device (either outside the network of the automated system for deal-making management, or indirectly via the service provider device connected to the network of the automated system);
the payer's management device (either outside the network of the automated system for deal-making management, or indirectly via the service provider device connected to the network).

The bank payment agent (BPA) provides via its management device:
requesting and receiving invoices from its service provider;
inclusion of invoices in a preliminary receipt, both together with other user purchases, and in a separately generated preliminary receipt;
provision of a final fiscal receipt to users acting as payers;
informing the user's service provider about payment of the invoice by a certain payer immediately after payment completion by the user acting as the payer (it does not matter whether the payment was made in cash or by wire transfer);
transfer of funds received as a result of the deal-making to final payees via BPA bank within the terms and conditions determined jointly with the payees on the basis of agreements.
preparation and transfer of a detailed register (one account is recorded in the register for each individual transfer of payer's money to the BPA's account), being a detailed breakdown for the transfer of aggregated amounts to both BPA bank and payees via their service provider.

Using the management device, the BPA interacts with:
the payer (directly or via the Internet using the payer's management device in accordance with the SP API protocol requirements);
the BPA service provider device (via SP API);
the payer bank management device (via API or PIS/AIS APIs);
the payee's bank management device (via payment protocols);
the BPA bank management device (via API or SP API).

The user, acting as the collateral bank, via their management device, credits funds as a performance bond to bank accounts opened for users, as well as transfers collateral funds to the user upon receipt of confirmation of compliance with the agreement terms (verdict) from the controlling authority.

Using its management device, the collateral bank:
as a result of the secured transaction launch-receives the payer's funds from the payer's bank and stores them;
informs the network of the automated system for deal-making management about crediting of these funds to its account;
stores funds received as a result of the secured transaction launch, from the moment of crediting the payer's funds received to secure settlements within the secured transaction until the moment when, by the order of the network of the automated system for deal-making management based on the controlling authority's verdict on the compliance with agreement terms, the funds for secure settlements are transferred to the payee's bank account in the payee's bank;
sends to the payee's bank the funds previously received as part of a secured transaction to secure future settlements, by the order of the network of the automated system for deal-making management, received as a result of a verdict of the controlling authority on the fulfillment of the terms of the secured transaction by the payee;
subsequently informs the network of the automated system for deal-making management about debiting of funds from the payer's account and their transfer to the payee's bank from the payer's bank account.

Using its management device, the BPA bank:
as a result of collection by BPA or transfer of money to the BPA's account receives the payer's funds from the payer's bank and stores them,
informs the network of the automated system for deal-making management about crediting of these funds to the BPA's account;
stores the funds on the BPA's account, received as a result of the described actions by BPA;
sends funds received earlier, by BPA's order to the payee's account in the payee's bank;
subsequently informs the network of the automated system for deal-making management about debiting of funds from the BPA's account and their transfer to the payee's bank on the payee's bank account.

Using the management device, the collateral bank interacts with:
user service provider (via SP API);
with the management device of the controlling authority (only indirectly via the network of the automated system for deal-making management).

Using its management device, the BPA interacts with:
user service provider (via SP API);
with the BPA management device (directly via proprietary protocols and indirectly via the network of the automated system for deal-making management).

Using its management device, the Operational and Clearing Center (OPCC):
receives orders to transfer funds from payers' banks, processes and routes them to payees' banks, as well as processes and routes orders to transfer funds to the settlement system;
receives requests for authorization from BPA banks and routes them for authorization to payers' banks, receives responses and returns them to BPA banks;
receives payment orders, processes them in clearing, generates net positions and sends them to the settlement system, as well as sends reports to users' banks.

Thus, as a result of the foregoing, it should be noted that the process of concluding a deal-related agreement is aimed at publishing it in CMD of the automated system for management of deal-making and ensuring approval of its terms by all parties. The agreement is concluded between users (parties to the agreement), and the minimum number of parties to the agreement is two, and the maximum number is not limited. Moreover, any agreement defines a comprehensive set of arrangements between the parties to the agreement. For example, one party under the agreement undertakes to supply some goods, and the other party undertakes to pay for it.

The above technical means for implementing the claimed invention make it possible to increase the reliability and accelerate information processing when making deals, as well as improve the user service quality by eliminating non-payments due to the “lack of information” or “non-delivery of invoices”, reduce the likelihood of errors in payments, accelerate information processing and the document flow. The above technical solution also makes it possible to increase the reliability of deal-making by improving the quality of reconciliations, as well as providing users with reports on compliance with the agreement terms (reconciliation reports). By reducing the load on the automated system for deal-making management, the speed of transactions processing in the said system increases.

The above benefits are confirmed by the following embodiments.

### EMBODIMENTS OF THE INVENTION

### Embodiment 1. Registration and Authentication

The user's management device receives a notification that registration was successful, after which the user is redirected to the main page of the application or the website of the service provider device 4. Next, using the device of their service provider 4, the user sends a request to the selected bank so that it performs authorization. Using its management device 7, the user's bank authorizes the user in any way convenient for it. If the service provider 4 cannot independently authorize the user, then the service provider allows the user to select the authorization channel. As soon as the user confirms their data via the selected bank, the user bank returns the authorization token to the user's management device (2 or 3) for subsequent access to CMD 1.

Authorization using a token occurs as follows. Using their management device 2 or 3, the user (payer) requests access to a server or protected resource (service provider device 4 or payer bank management device 7) by providing the token. Access is granted or, conversely, denied based on the issued token. After that the service provider 4 sends a request to CMD 1 to publish a user (payer) account. All data about users and their preferences are stored in the centralized database of CMD and each user is assigned a unique identifier.

### Embodiment 2. Deals Between Legal Entities (B2B Transaction)

1. Supply of products to supermarkets, restaurants, cafes from suppliers.
2. Supply of computer equipment to companies specializing in computer assembly.
3. Supply of raw materials for production to factories and plants.
4. Delivery of cars to car dealers.
5. Supply of cosmetics, household chemicals, clothing, shoes, etc. to specialized stores.
6. Payment for construction, cleaning, security, repair, cargo transportation services.
7. Payment for insurance.

Use of a B2B transaction invoicing service will make it easier for parties to issue and pay invoices, and will also increase B2B reliability by implementing a reconciliation mechanism in the automated system for deal-making management.

### Embodiment 3. Deals Between Legal Entities and Individuals (C2B Transactions)

Parties interact online using the interface provided by the payee (mobile application, website).
1. Online shopping

Delivery of food, groceries, purchase of clothing, household appliances, shoes, furniture, cosmetics, flowers, tools, jewelry, equipment, auto parts, household goods, books.
2. Payment for the services of cleaning companies, lawyers, tutors, loaders, cargo transportation.

Deals between legal entities and individuals with instant delivery of goods:
1. Purchase of tickets to concerts, theaters, cinemas, sports matches, air tickets.
2. Hotel booking.
3. Purchase of tourist tours.
4. Purchase of software.
5. Purchase of insurance.
6. Payment of taxes, duties, fines.

Convenient mechanism for periodic invoicing for subscription-related deals:
1. Topping up personal accounts with service operators.
2. Toll roads.
3. Payment for subscriptions to music and video services.
4. Payment for periodic grocery deliveries, such as weekly meal kits delivery.
5. Payment for parking.
6. Payment of rent.
7. Payment for gym, swimming pool, fitness club membership.

Gifts (one of the parties provides a donation to the other party free of charge), for example, charitable donations.

Tracking of charitable donations is an extremely difficult task for the government. The deal support service will simplify this task by providing an invoice tracking mechanism and a convenient method for donation making involving provision of a QR code or a link to the account by a charity organization to a donor. The donor scans the QR code or follows the link and makes a donation. There are no forms to fill out.

Invoices for offline transactions:
1. Purchase of food in canteens, cafes, restaurants, fast food restaurants.
2. Grocery shopping at the supermarket.
3. Purchase of jewelry, household goods, fishing goods, medicines, flowers, construction goods, furniture, plumbing equipment, household appliances in the store.

During such transactions, the interaction takes place offline, for example, in a store. Currently, there is a problem of filing claims against a supplier of goods or services if the evidence of a transaction (cash receipt) is lost. Although the law provides for a refund if the receipt is lost, however, in practice, the buyer faces a number of difficulties. The use of an invoicing mechanism and the deal support service will simplify the filing of claims against the seller, because the buyer will have an electronic document confirming the payment.

Payment for housing and utility services.

The existing mechanism for paying for housing and utility services is inconvenient both for property management companies and service consumers. A huge number of property management companies issuing invoices makes the situation even more confusing. The deal support service provides payers with a convenient mechanism for paying and receiving invoices, including batch payments (all invoices from property management companies can be paid with one click), as well as providers of housing and utility services with a convenient mechanism for invoices delivery and reconciliation.

### Embodiment 4. Deals Between Individuals (P2P Payments)

This type of deals provides for interaction between individuals. Such deals are hidden from the government; it cannot monitor them and provide legal protection to the parties. The deal support service will help to eliminate these downsides, and also, alongside with strengthening of government control over P2P transactions, will provide a convenient payment and invoicing mechanism in a timely manner.

Examples of such deals may include:
1. Purchase of used goods, for example, via online advertising services.
2. Payment for services of private tutors, constructors, movers, plumbers, computer repairers.
3. Payment of rent.
4. Payment of debts between individuals.

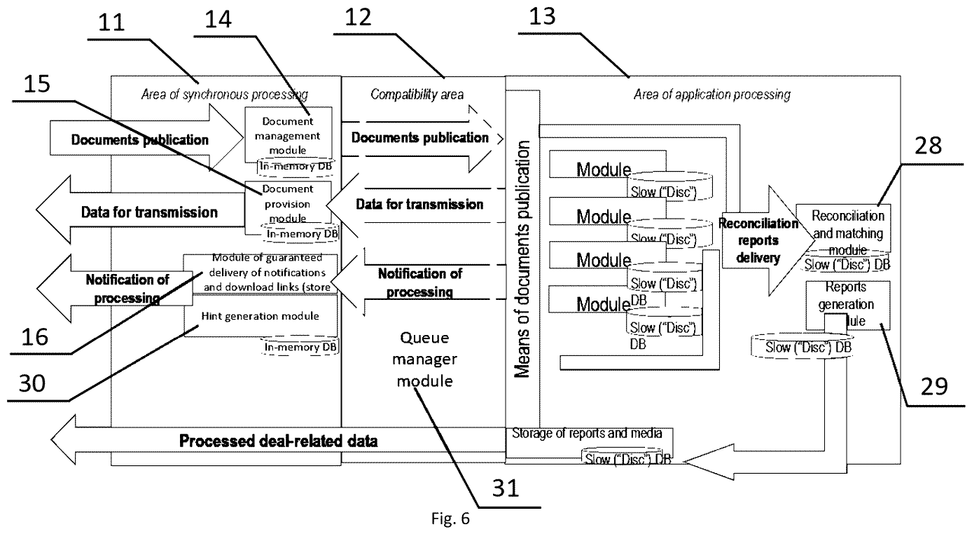

### Embodiment 5. Making of Deals Between Users With Participation of OPCC (FIG. 6)

The initiator of a funds transfer can be the user either as a payer or a payee.

The Operational and payment clearing center (OPCC) via its management device:
receives requests from at least one user's bank management device for the funds transfer and processes them;
identifies payees and sends requests to them;
receives responses to requests and matches them with original requests;
receives direct payment orders (claims) and sends them for clearing;
performs clearing of counter unaccepted payment orders (claims);
based on clearing results, generates a register of net positions for direct transfer of funds between banks, clearing reconciliation reports for users containing the elementary components of each net position;
sends either a net position register or an order to transfer funds for a separate transaction to the settlement bank of the payment system;
sends a reconciliation report or notification of completed settlements to users' banks participating in the funds transfer.

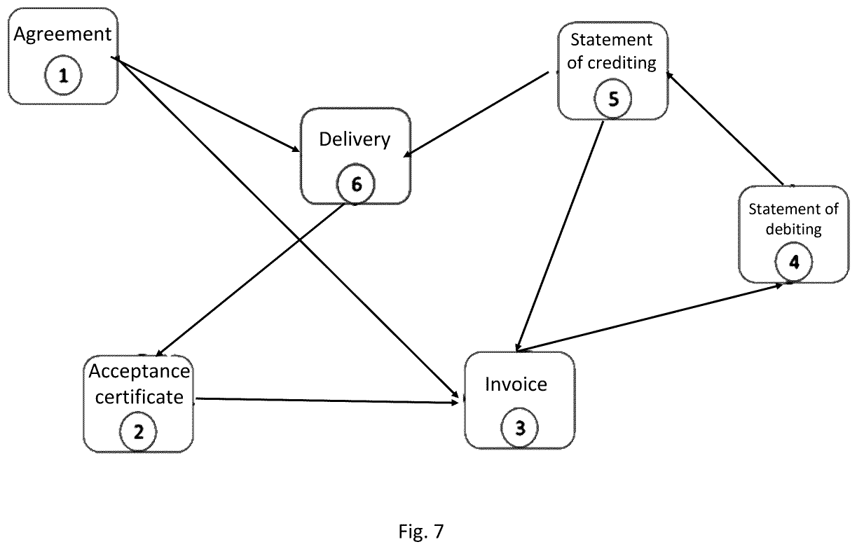

Embodiment 6 of a template scenario for one agreement in the form of a direct cyclic graph is shown in FIG. 7. As can be seen, from the state (1) “agreement”, according to the template, the scenario can go to the state either (3) “invoice” or (6) “delivery”. This example of the scenario provides for a transition from state (6) “delivery” only to the next state (2) “acceptance certificate”, from which only a transition to state (3) “invoice” is possible. According to this scenario, there are two paths: either through the successive states (4) “statement of debiting” and (5) “statement of crediting” the process goes to state (6) “delivery”, from where there will be a transition to state (2) “acceptance certificate” and to state (3) “invoice”, after which the process will again go to state (4) “statement of debiting”. And this will be repeated as many times as required (the number of cycles will depend on the number of deliveries);

or through the successive states (4) “statement of debiting” and (5) “statement of crediting” the process will go to state (3) “invoice”, after which process will again go to state (4) “statement of debiting”. And this will be repeated as many times as required (depending on the number of payments provided for one delivery acceptance certificate; this is an example of payment against an acceptance certificate in installments)

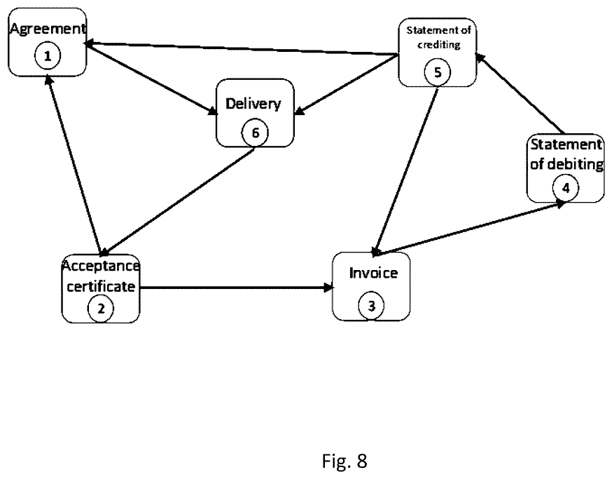

Embodiment 7 of a scenario template for a set of related agreements in the form of a direct cyclic graph is shown in FIG. 8.

The difference from FIG. 7 is that in this direct cyclic graph there is an edge connecting state (5) “statement of crediting” with state (1) “agreement”, which means the transition from one agreement to the next one, provided for by a complex scenario (consisting of many agreements).

Embodiment 8 comprising calculation of the number of requests allowed to the payer using a hint identifier.

A set of parameters for user categorization, set by CMD is used to determine a user's category.

Parameters stored in the centralized database in CMD are used to set the parameters according to which users are categorized.

Such parameters include, in particular, but not limited to the following:
whether the user is an individual or a legal entity;
the type and volume of activity carried out by the user (for example, the number of requests for an individual registered as self-employed will exceed the number of requests provided to an individual, but will be less than the number of requests provided to a legal entity, e.g., for a property management company);
status of a legal entity assigned upon registration (simply a payee or VIP payee);
additional, including commercial, categorization terms (for example, a fee for an increased number of requests for one hint identifier for obtaining documents of certain types).

At least two categories of users are determined; after that this data is sent to the hint generation module. For each user category in CMD sets the number of requests allowed by a hint.

For service providers of individuals acting as payers, the system can set a limit on the number of free requests (e.g., from 1 to 3); if such limit is exceeded, the user's service provider will be charged at the rate established by CMD. The number of requests for service providers of legal entities acting as payees is set in the same way (for example, from 1 to 3). For service providers of VIP payees, the number of free requests can be increased, for example, up to 5.

Such limits are due to the following circumstance: CMD shall notify any service provider at any time of any publication or any modification of any document. And the rules of the system, established by CMD, provide for a requirement for service providers to remember and provide users of any type with information about documents upon their requests independently without contacting CMD, since they are the owners of up-to-date information. If any update occurs on the side of CMD, then, as established, CMD will again notify the service provider, which will update the information in its system by contacting CMD, after which it will again have up-to-date information to provide it to users without direct interaction with CMD. The methods and practice described herein were internationally named “caching”; the service provider acts herein as a “cache”, i.e., an intermediate information buffer with quick access to it upon user requests.

1. An automated system for information exchange in a deal support service, comprising a centralized management device for information exchange in the deal support service configured to provide support when making a deal and at least two user's management devices with installed user interface, using communication channels to ensure access of the user's management device to the centralized management device for the purpose of information exchange in the deal support service via at least one service provider device, wherein
the centralized management device for information exchange in the deal support service is configured as a hardware and software system for automation of deal-making management and comprises an area of synchronous processing configured to generate quick responses to user requests and their submission to the user, a compatibility area configured to queue deal-related requests, and an area of application processing configured to perform synchronous and asynchronous processing of user requests and logical control of information about deal-making from users,
wherein, the centralized management device for information exchange in the deal support service contains a control means configured to limit the number of user's requests for deal-related information sent via communication channels to the centralized management device for information exchange in the deal support service to a set number of times.

2. The system for deal-making management according to claim 1 comprises at least one user's bank management device configured to function as a service provider and connected to the centralized management device via communication channels.

3. The system for deal-making management according to claim 2, wherein the user's bank management device is connected to the centralized management device using communication channels via at least one service provider device.

4. The system for deal-making management according to claim 1, wherein users' means of communication with installed user interface for indirect access (via a service provider) to the centralized management device are used as users' management devices.

5. The system for deal-making management according to claim 1 comprises at least one intermediate bank management device configured to function as a service provider and connected to the centralized management device via communication channels.

6. The system for deal-making management according to claim 5, wherein the intermediate bank management device is connected to the centralized management device using communication channels via at least one service provider device.

7. The system for deal-making management according to claim 1 comprising at least one controlling authority management device configured to function as a service provider and connected to the centralized management device via communication channels.

8. The system for deal-making management according to claim 7, wherein the controlling authority management device is connected to the centralized management device using communication channels via at least one service provider device.

9. The system for deal-making management according to claim 1 comprising at least one bank payment agent management device configured to function as a service provider and connected to the centralized management device via communication channels.

10. The system for deal-making management according to claim 9, wherein the bank payment agent management device is connected to the centralized management device using communication channels via at least one service provider device.

11. The system for deal-making management according to claim 1 comprising at least one operational clearing center management device connected to at least one user's bank management device and an intermediary bank management device via communication channels.

12. The system for deal-making management according to claim 1, wherein the centralized management device is configured to manage a user's profile.

13. The system for deal-making management according to claim 1, wherein the device of at least one service provider is configured to provide a user with an interface for registration, identification parameters check and user authentication, as well as for data storage by creating a new user account.

14. The system for deal-making management according to claim 1, wherein a hint generation module and a document provision module checking the number of hint use are used as means of control designed to limit the number of users' requests for deal-related information sent via communication channels to the centralized management device to a set number of times.

15. The centralized management device for information exchange in the deal support service comprising a centralized database configured to store information about user registrations, credentials and preferences, as well as means of automation of deal-making management,
wherein, means of automation of deal-making management comprises
at least a means of deal-related documents receipt and submission to the user, containing a document management module, a document provision module, a module of guaranteed delivery of notifications and download links (a store and forward module), a hint generation module, and a queue manager module, wherein the hint generation module and the document provision module forms a control means designed to limit the number of user's requests for deal-related information, and the queue manager module queues deal-related requests during asynchronous request processing;
at least a means of deal-related documents publication, at least a means of deal-related documents categorization, and at least a means of deal scenario generation, wherein the specified means are intended for synchronous and asynchronous processing of user requests for deal-making.

16. The centralized management device according to claim 15, wherein means of deal-related documents publication comprises a user profile module and a service subscription module.

17. The centralized management device according to claim 15, wherein the means of deal scenario generation comprises an agreement module, a transfer and acceptance certificate module, an invoice module, a module for payer's bank statement of debiting, a module for payee's bank statement of crediting, a template module, a verdict module, a redirection module, a claim module and a report generation module.

18. The centralized management device according to claim 15, wherein a means of deals classification comprises a document reconciliation module.

19. The centralized management device according to claims 16-18, wherein all modules included in the means of deal-related documents publication, the means of deal scenario generation, and the means of deals classification contain filters configured to match documents related to deals and contained in the queue manager module with each other.

20. The centralized management device according to claims 15-18, wherein the centralized database consists of databases of all modules of the centralized management device, forming a single network via communication channels.

21. The centralized management device according to claim 15, wherein the document management module is configured to perform parsing and validation.

22. The centralized management device according to claim 16, wherein the means of deal-related documents publication is configured to publish full information about deal-making in the automated system according to claim 1 for the first time and share a link to the previously published information.

23. The centralized management device according to claim 16, wherein the means of deal-related documents publication is configured to receive and provide information about deals at user requests through the use of a unique hint.

24. The centralized management device according to claim 16, wherein the means of deal-related documents publication is configured to generate and provide reports about deals to users.

25. The centralized management device according to claim 1, wherein the centralized database comprises unique identifiers relevant to each user and at least one user's service provider.

26. What is claimed is an automated method for information exchange in the deal support service comprising provision of access to the centralized management device for at least two users via communication channels via at least one service provider device; registration of a user, storage of access credentials of each user in the centralized database,
the method comprising:
creating user account;
providing each user with access to one or at least two service providers at the same time;
authenticating a user via user's service provider;
publication of a deal-related document on the network of the automated system for deal-making management;
generating a user request for making a deal on a user's management device;
categorizing the incoming information on the centralized management device via means of deals classification;
generating a deal on the centralized management device the centralized database of which stores deal scenario templates for approval, confirmation and making of various deals;
registering, comparing and tracking deal-related agreements;
via hints, controlling the number of requests for deal-related documents received through communication channels and access of a user's device to the deal-related information.

27. The automated method for deal-making management according to claim 26 comprising posting of a user account and deal-related information on the centralized management device after the user's authorization check by the user's service provider device.

28. The automated method for deal-making management according to claim 26 comprising storage of data on user preferences in the centralized database of the centralized management device.

29. The automated method for deal-making management according to claim 26 comprising generation of a unique identifier for each deal and for each document in the centralized management device.

30. The automated method for deal-making management according to claim 26 comprising provision of access to deal-related information at user request.

31. The automated method for deal-making management according to claim 26 comprising provision of a user with means of account editing in the centralized management device.

32. The automated method for deal-making management according to claim 26 comprising matching of documents related to deals and contained in the queue manager module with each other using filters of modules contained in means of deal-related documents publication, means of deal scenario generation, and means of deals classification according to claims 15-17.

33. The automated method for deal-making management according to claim 26 comprising making of secured transactions after the controlling authority management device's confirmation of users' compliance with deal conditions.
